(19) United States
(12) Patent Application Publication
(10) Pub. No.: US 2022/0242549 A1
(43) Pub. Date: Aug. 4, 2022

(54) Storm Avoidance System for LTA Vehicle

(71) Applicant: LOON LLC, Mountain View, CA (US)

(72) Inventor: Ewout van Bekkum, Sunnyvale, CA (US)

(73) Assignee: LOON LLC, Mountain View, CA (US)

(21) Appl. No.: 17/167,446

(22) Filed: Feb. 4, 2021

(51) Int. Cl. B64B 1/64; B64B 1/40; B64D 45/00

(52) U.S. Cl. CPC B64B 1/64; B64D 45/00; B64B 1/40

(57) ABSTRACT

The technology relates to a storm avoidance system for a lighter than air (LTA) vehicle. The storm avoidance system can include a mechanical actuation system, a balloon envelope comprising a ballonet, and a valve configured to allow air to escape the ballonet. When the storm avoidance system is engaged, the mechanical actuation system can open the valve, thereby allowing air to escape the ballonet and causing the LTA vehicle to ascend to an altitude above a storm altitude. In some cases, a state of the LTA vehicle can be detected, and the storm avoidance system can be engaged in response to the detected state. In some cases, a proximity of the LTA to a low population area can be determined, and the LTA vehicle can be caused to land in the low population area.

### BACKGROUND OF INVENTION

Fleets of lighter than air (LTA) aerial vehicles are being considered for a variety of purposes, including providing data and network connectivity, data gathering (e.g., image capture, weather and other environmental data, telemetry), and systems testing, among others. LTA vehicles can utilize a balloon envelope, a rigid hull, or a non-rigid hull filled with a gas mixture that is lighter than air to provide lift. In other words, the gas that is lighter than air within the envelope displaces the heavier air, thereby providing buoyancy to the LTA vehicle. Some LTA vehicles are propelled in a direction of flight using propellers driven by engines or motors and utilize fins to stabilize the LTA vehicle in flight.

### BRIEF SUMMARY

The present disclosure provides techniques for a storm avoidance system for an LTA vehicle. A storm avoidance system for a lighter than air (LTA) vehicle can include: a mechanical actuation system being controlled by a mechanical actuation system controller; a balloon envelope comprising a ballonet; and a valve coupled to one or both of the balloon envelope and the ballonet, the valve configured to allow air to escape the ballonet, wherein the mechanical actuation system controller is configured to cause the mechanical actuation system to open the valve, and wherein the air escaping the ballonet causes the LTA vehicle to ascend to an altitude above a storm altitude. In an example, the mechanical actuation system comprises a squib configured to cause the valve to open. In another example, the valve further comprises a spring configured to provide a tension, and a retaining bolt configured to prevent the valve from opening until the retaining bolt is broken or displaced by the squib. In another example, the mechanical actuation system comprises an electromechanical system configured to cause the valve to open. In another example, the mechanical actuation system controller is configured to autonomously actuate the mechanical actuation system to trigger in response to a state of the LTA vehicle. In another example, the state of the LTA vehicle comprises at least a partial loss of command and control of the LTA vehicle. In another example, the mechanical actuation system controller is configured to cause the mechanical actuation system to trigger in response to a manual signal from an operator. In another example, the valve is controlled independently from an altitude control system. In another example, the storm altitude is 40,000 feet or above.

A method for operating a storm avoidance system for an LTA vehicle can include: detecting, using a processor, a state of an LTA vehicle; triggering a mechanical actuation system, using a mechanical actuation system controller, the mechanical actuation system configured to open a valve coupled to one or both of a balloon envelope and a ballonet, wherein the ballonet is filled with air, and wherein opening the valve causes the air to escape the ballonet and causes the LTA vehicle to ascend to an altitude above a storm altitude; determining that the LTA vehicle is within a proximity of a low population area, the proximity indicating an appropriate distance and direction of travel to begin a descent for landing in the low population area; and causing the LTA vehicle to land in the low population area. In an example, the triggering the mechanical actuation system comprises firing a squib, wherein the squib is configured to open the valve. In another example, the triggering the mechanical actuation system comprises actuating an electromechanical system configured to open the valve. In another example, the triggering the mechanical actuation system comprises autonomously actuating the mechanical actuation system to trigger in response to a state of the LTA vehicle. In another example, the state of the LTA vehicle comprises a partial loss of command and control or a total loss of command and control, or a flight duration time longer than a predetermined flight duration time. In another example, the triggering of the mechanical actuation system controller is performed in response to a manual signal from an operator. In another example, the storm altitude is 40,000 feet or above. In another example, the above method further includes receiving data from a forecast or a nowcast model, wherein the data includes one or more of a location of a storm, a proximity of a storm to the LTA vehicle, the maximum altitude of a storm, a projected direction or travel and/or a projected speed of travel of a storm. In another example, the data is used by the weather avoidance system to determine when to trigger the mechanical actuation system. In another example, the above method further includes, after triggering the mechanical actuation system and before causing the LTA vehicle to land in the low population area, causing the LTA vehicle to drift in a low power mode. In another example, the descending the LTA vehicle until it touches down in the low population area further comprises selectively cutting, using a flight termination unit, a portion and/or a layer of the balloon envelope containing lifting gas.

### BRIEF DESCRIPTION OF THE DRAWINGS

FIG. 1 is a simplified schematic of an example in side view of an LTA vehicle with a storm avoidance system, in accordance with some embodiments.

FIGS. 2A and 2B show a simplified schematic example in side view of a portion of a storm avoidance system of an LTA vehicle, in accordance with some embodiments.

FIGS. 3A and 3B are diagrams of example LTA vehicle systems incorporating storm avoidance systems, in accordance with some embodiments.

FIG. 4 is a simplified block diagram of an example of a computing system forming part of the systems of FIGS. 3A and 3B, in accordance with one or more embodiments.

FIG. 5 is a flowchart of a method 500 for operating a storm avoidance system of an LTA vehicle, in accordance with some embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The invention is directed to a storm avoidance system for a lighter than air (LTA) vehicle. In some cases, a valve to a ballonet or other container containing ballast air is opened, which releases air from the ballonet or container, thereby causing the LTA vehicle to ascend to an altitude above the maximum altitude of typical storms. In some cases, ballast (e.g., air, water, sand or steel shot) can be released by the storm avoidance system causing the LTA vehicle to ascend to an altitude above the maximum altitude of typical storms. For example, many storm clouds have maximum storm altitudes of approximately 40,000 to 60,000 feet (or up to approximately 75,000 feet for tropical storms), and the storm avoidance system can cause the LTA vehicle to ascend to altitudes above a maximum storm altitude, such as above 40,000 feet, above 60,000 feet, or above 75,000 feet. Ascending above the altitude of the storms can effectively protect the LTA vehicle from storm induced damage, such as due to high winds, precipitation, and/or electrical events (e.g., direct lightning strike, lightning transient, other electrical transients).

In some cases, the storm avoidance system can automatically engage in response to a state of the LTA vehicle. For example, if an LTA vehicle experiences a total or partial loss of command and control, then the storm avoidance system can automatically engage and ascend the LTA vehicle to an altitude above maximum storm altitudes. LTA vehicles can be controlled using various types of commands, and a total or partial loss of command and control can describe a state where one or more types of commands cannot be received and/or one or more systems of the LTA vehicle cannot be controlled. For example, an LTA vehicle can receive commands from an offboard system (e.g., a ground station, or another aerial vehicle) and those commands can be used to control various subsystems of the LTA vehicle. An example of a total or partial loss of command and control is the LTA vehicle failing to receive one or more commands from the offboard system and/or the LTA vehicle being unable to control one or more of the various systems (e.g., the LTA vehicle being unable to act on or respond to a received command). In other cases, the storm avoidance system can be manually controlled, for example, by an operator using a system that is in communication with the LTA vehicle.

The storm avoidance system can also engage in response to other states of the LTA vehicle, such as in response to a proximity to a storm, a proximity to an aircraft flight route, and/or a proximity to a high population density region. For example, a storm sensing system can be used to detect the proximity of the LTA vehicle to a storm and the storm avoidance system can engage in response to the system determining that a measure of risk has crossed a threshold. The storm sensing system can use a storm map and/or a storm risk map to determine when and/or where it may be beneficial to engage the storm avoidance system to ascend to an altitude above the maximum altitude of a storm. In another example, a population density and/or an aircraft flight route map can be used to determine when and/or where to engage the storm avoidance system to ascend above the altitude of a potential storm. Engaging the storm avoidance system when the LTA vehicle is the proximity of a high population area and/or a busy aircraft flight route can improve safety by reducing the probability that the LTA vehicle is affected by a storm. In general, the storm avoidance system can prioritize safety over protecting the LTA vehicle components, such as by ascending above a storm altitude in response to a potential storm risk even at the risk of damaging or permanently degrading the LTA vehicle. In some cases, systems that determine the proximity of the LTA vehicle to a storm, a busy aircraft flight route, and/or a high population density region can operate during a partial or total loss of command and control. In some cases, the systems that determine the proximity of the LTA vehicle to a storm, a busy aircraft flight route, and/or a high population density region can provide one or more signals to the storm avoidance system to automatically engage the storm avoidance system during a partial or total loss of command and control.

In some cases, an LTA vehicle can use a ballonet inside of a balloon envelope to control the altitude. For example, valves and blowers can be used to inflate and deflate the ballonet. The ballonet can be inflated with air or another gas that is heavier than air, either from outside the LTA vehicle or from a gas cylinder. The lifting gas (e.g., helium) within the envelope expands or contracts when the ballonet is deflated or inflated, respectively, causing the vehicle to ascend or descend. In some cases, a plurality of ballonets is positioned within the envelope such that the lifting gas expands and contracts uniformly across the vehicle.

An LTA vehicle can utilize a flight termination system (FTS) to protect the vehicle at the end of a flight. In some cases, an FTS can detach a payload from the balloon envelope and cut an opening in the balloon envelope. In some cases, an LTA vehicle can be fitted with an inflatable bag attached to a gas cylinder that can slow the rate of descent of an LTA vehicle. For example, in response to an acceleration sensor detecting that the LTA vehicle is accelerating too quickly (e.g., while falling to the ground), the bag can be filled with a lighter than air gas (e.g., helium) from the gas cylinder to slow the rate of descent of the vehicle, thereby decreasing the amount of damage caused or sustained upon impact with the ground.

In some cases, an LTA vehicle can contain a flight termination system (FTS) and a storm avoidance system, where one or both systems may be engaged in response to a state of the LTA vehicle. For example, the FTS and/or the storm avoidance system can engage when the LTA vehicle experiences a problem (e.g., a loss of command or control functionality), or reaches a planned end of flight time (e.g., when a self-termination timer elapses). In some cases, the FTS may instruct the LTA vehicle to drift (e.g., in an emergency low power mode) while waiting to find a low population area to safely descend (e.g., using a flight termination unit as described herein). The FTS may instruct the LTA vehicle to drift at its current altitude, or it may instruct the LTA vehicle to change altitude and then drift until it is over a low population area. The LTA vehicle can determine if it is over a low population area, for example, using GPS geofencing and onboard timers. In some cases, the FTS can determine that (or when, or if) the LTA vehicle is within a proximity of a low population area, where the proximity indicates an appropriate distance and direction of travel to begin a descent for landing in the low population area. In some cases, an offboard system (e.g., a fleet management system and/or a dispatcher receiving telemetry from the LTA vehicle, and optionally sending commands to the LTA vehicle) can determine if the LTA vehicle is over a low population area. For example, onboard GPS maps, that can be updated during a flight, can tell the vehicle that it is within a certain population density area. In some cases, timers can be used to determine a planned end of flight time (e.g., based on total flight duration, projected drift, or other heuristics). In some cases, the FTS can instruct the vehicle to drift for hours, days, or weeks before safely causing the LTA vehicle to land in the low population area. Although the risk of running out of power in such situations can be resolved by autonomously powering off non-essential onboard equipment, the risk of storm induced unplanned flight termination increases as the time that the vehicle drifts (potentially at lower altitudes) increases. Therefore, LTA vehicles that contain a storm avoidance system can be beneficial to enable the LTA vehicle to avoid storms while the LTA vehicle is drifting.

In some cases, the FTS and/or the storm avoidance system may be engaged in response to an end of a flight of an LTA vehicle (either planned or unplanned). In some cases, the end of the flight of the LAT vehicle can be determined using an LTA vehicle health and lifetime estimation system. In some cases, the LTA vehicle health and lifetime estimation system comprises an estimation service configured to use flight data inputs to estimate a remaining lifetime value (e.g., number of days, value representing projected loss of lift gas or remaining lift gas over time (i.e., deterministic), computed or simulated probabilities of remaining days airborne until zero pressure (i.e., probabilistic)). The health of a component (e.g., navigation, power, other hardware subsystem, and other component) of the LTA vehicle also may be estimated, the component health estimates used as inputs to the LTA vehicle health and lifetime estimation system to base an LTA vehicle lifespan on the health of one or more constrained components. The terms “lifespan” and “lifetime” are used interchangeably herein to mean an amount of time between a launch and a landing during which an LTA vehicle may have a full set of, or substantial, mission capabilities (e.g., can perform all or most or a threshold amount of missions for said vehicle type, which in some cases may include the full amount of time between the launch and the landing, and also may be related to its ability to access most or all of a steering range (e.g., between a bursting pressure threshold and a zero pressure threshold, which may be set to include a buffer below an actual bursting pressure and above an actual zero pressure)), which may be expressed as a value, a risk (e.g., odds or probability of a zero pressure in within a given time frame (e.g., 15 days, 20 days, 2 months, etc.), and distribution of values or probabilities over time.

The storm avoidance system can operate by actuating the opening of a valve to release air from a ballonet or other container within the balloon envelope of the LTA vehicle. The valve can be any valve that is coupled to a ballonet or other container within the balloon envelope containing a volume of air (or other gas that is heavier than air). For example, the valve can be part of an ACS, a hard-launch valve, or an emergency valve. In some cases, the valve for the storm avoidance system is a large valve, such as a hard-launch enabling valve which can be made larger than a typical superpressure balloon ACS valve. A larger valve will allow air to escape more quickly and enable a faster ascent rate, which is beneficial because the time to ascend to an altitude above a typical storm maximum altitude is shorter. In some cases, the valve that is used by the storm avoidance system is a venting ballast air valve that can also be used to vent ballast air (e.g., from a ballonet) during flight (e.g., to control the altitude of the LTA vehicle). The venting ballast air valve can be a valve that is part of the ACS, a hard-launch valve, or an emergency valve. Using a dedicated valve that is more reliable than other valves (e.g., a venting ballast air valve can be more reliable than a primary ACS valve) can be beneficial to improve the reliability of the storm avoidance system.

In some cases, a squib (i.e., a miniature explosive) can be used to actuate opening the valve, causing the LTA vehicle to ascend to an altitude above the maximum altitude of typical storms. A squib, controlled by a squib controller, can open a valve (e.g., an emergency valve) for a storm avoidance system robustly and reliably. A storm avoidance system utilizing a squib actuated valve opening mechanism can be beneficial compared to, for example, using an altitude control system (ACS) to control an ascent valve because the ACS can have many dependencies for it to function making it less reliable than a squib actuated system.

In other cases, an electromechanical or electrochemical system (other than a squib) can be used to actuate opening the valve, causing the LTA vehicle to ascend to an altitude above the maximum altitude of typical storms. For example, a valve can be equipped with an electric motor that is controlled to open the valve based on an electrical signal. In another example, a chemical reaction can be used to provide a force to open a valve. For example, a chemical reaction similar to those used by automobile airbags (e.g., to inflate the airbag with nitrogen gas) can be used to generate a gas which can then provide a force to open a valve (e.g., by expanding a bellows coupled to the valve).

In some cases, a valve for a storm avoidance system can be under constant tension to open and a retention mechanism can be used to prevent the valve from opening. A squib (or other electrochemical or electromechanical system) can be used to break the retention mechanism, thereby allowing the constant tension to open the valve. For example, the valve could be spring-loaded (i.e., the constant tension can be provided by a spring) and held in place by a retaining bolt or wire. Upon actuation by the storm avoidance system, the bolt or wire could be broken or otherwise displaced by the squib (or other electrochemical or electromechanical system), thereby allowing the valve to open due to the force from the spring.

In some cases, the storm avoidance system causes the LTA vehicle to ascend to an altitude above a maximum storm altitude in less than a given amount of time (e.g., 10 minutes, 30 minutes, 1 hour, or less than 6 hours), allowing the LTA vehicle to drift for longer times (e.g., until it is over a low population density region) with less chance of being impacted by a storm. In some cases, the rate at which the LTA vehicle ascends to an altitude above a maximum storm altitude is determined dynamically, for example, based on the proximity of the LTA vehicle to a storm. The time for an LTA vehicle to ascend from a typical float altitude to one that is above a maximum storm altitude is tunable, for example, by using a larger or smaller valve. The system characteristics can be chosen, for example, based on a risk tolerance of encountering storm damage compared to a potential leak rate from the storm avoidance system valve, as well as other factors such as cost, mass, and valve complexity.

In some cases, a storm avoidance system for an LTA vehicle can release ballast (e.g., air, water, sand or steel shot), thereby causing the LTA vehicle to ascend to an altitude above the maximum altitude of typical storms. For example, water, sand or steel shot can be contained in a container or bag coupled to the LTA vehicle, and a mechanical actuation system can be used to drop the ballast by dropping the whole container or bag, or by opening the container or bag such that the ballast (e.g., water, sand or steel shot) is dropped. In some cases, the mechanical actuation system used to drop the ballast can be triggered by firing a squib.

The storm avoidance system can cause the LTA vehicle to ascend to altitudes above a maximum storm altitude, such as above 40,000 feet, above 60,000 feet, or above 75,000 feet. In some cases, the altitude of the vehicle after the storm avoidance system is activated is determined by a maximum float altitude of the LTA vehicle, which can be determined by the initial amount of lighter than air gas in the envelope, an amount of lighter than air gas leaked, and the amount of ballast dropped. In some cases, the float altitude of the LTA vehicle after the storm avoidance system has engaged can be slightly higher than a usual maximum float altitude, and in some cases can exceed (or become inconsistent with) usual ballonet constraints that inhibit ACS operations.

In some cases, the weather avoidance system is configured to receive weather data and/or infrared (IR) data (e.g., IR satellite imagery) from forecast and nowcast models (e.g., National Oceanic and Atmospheric Administration's (NOAA's) Global Forecast System (GFS), European Center for Medium-Range Weather Forecast's (ECMWF's) high resolution forecasts (FIRES), and the like). For example, the weather avoidance system can be controlled by a controller (or processor, or computer) that is coupled to a communication system that is configured to receive weather data and/or IR data. The weather data and/or IR data can include one or more of a location of a storm, a proximity of a storm to the LTA vehicle, the maximum altitude of a storm, a projected direction or travel and/or a projected speed of travel of a storm. In some cases, the weather avoidance system can receive weather data and/or IR data to determine the proximity of a storm to the LTA vehicle. In some cases, the weather data and/or the IR data can be used by the weather avoidance system to determine when to initiate one or more systems of the weather avoidance system. For example, the weather avoidance system can use received weather data and/or IR data to determine when to actuate a mechanical actuation system that opens a valve to a ballonet (or that causes other type of ballast to be dropped) thereby causing the LTA vehicle to ascend above the altitude of one or more storms indicated by the weather data and/or IR data. In some cases, the weather avoidance system can use received weather data and/or IR data to determine which valve of the system to open. For example, a weather avoidance system can contain two valves coupled to the ballonet, one of which has a larger opening than the other, the larger opening configured to allow air to be released from the ballonet at a higher rate (e.g., more volume per unit of time) than the smaller valve. In this example, if the weather data and/or the IR data indicates that a storm is relatively close to the LTA vehicle then the weather avoidance system can cause the larger valve to open, thereby causing the LTA vehicle to ascend to an altitude above the nearby storm more quickly than if the smaller valve were opened.

Example Systems

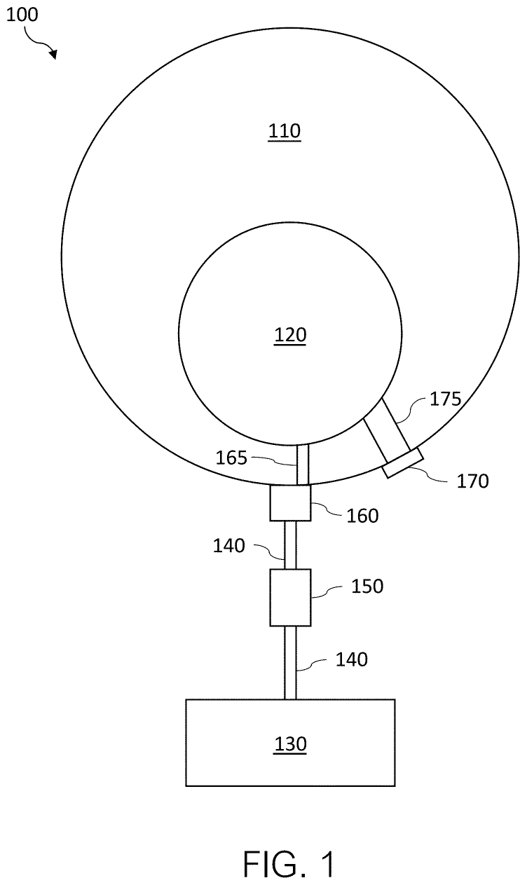

FIG. 1 is a simplified schematic of an example in side view of an LTA vehicle with a storm avoidance system, in accordance with some embodiments. LTA vehicle 100 includes a balloon envelope 110, a ballonet 120, a payload 130, and a down-connect 140 coupling the envelope 110 to the payload 130. Down-connect 140 can include other components 150. Ballonet 120 is coupled to valves 160 and 170 through tubes 165 and 175, respectively. The valves 160 and/or 170 can be controlled by one or more valve controllers to allow air to inflate or deflate ballonet 120, for example to control the altitude of LTA vehicle 100. The valve controller can be located with other electronic components in the payload 130 or in the down-connected components 150.

Valves 160 and/or 170 can also be used by the storm avoidance system to allow air to escape from ballonet 120 causing LTA vehicle 100 to ascend above the altitude of typical storms (e.g., above 40,000 feet, above 65,000 feet, or above 75,000 feet). Valves 160 and/or 170 can be opened using the valve controller (e.g., for an ACS) or a dedicated storm avoidance system valve opening mechanism. For example, valves 160 and/or 170 can be opened by the storm avoidance system using a system with one or more squibs, an electromechanical system, or an electrochemical system.

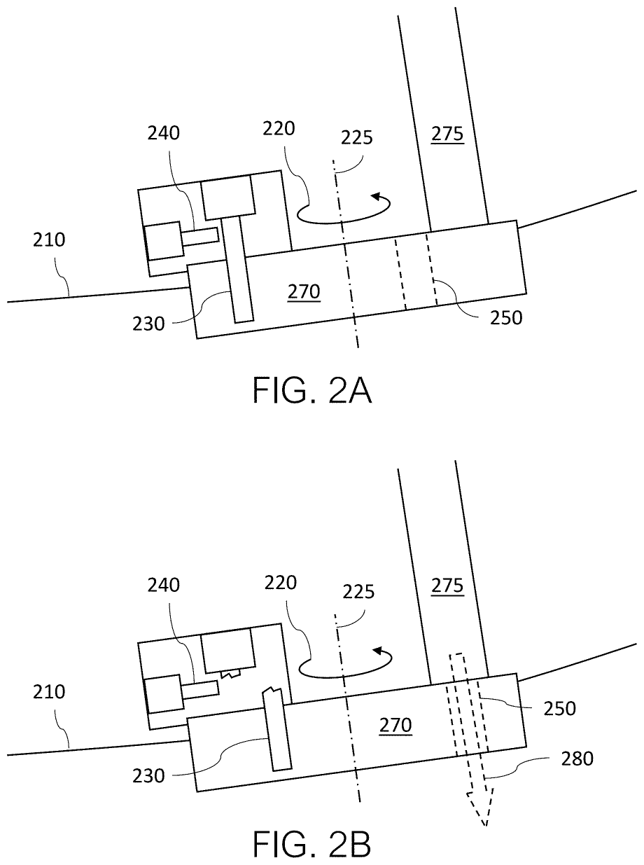

FIGS. 2A and 2B show a simplified schematic example in side view of a portion of a storm avoidance system of an LTA vehicle, in accordance with some embodiments. The storm avoidance system includes valve 270 intersecting balloon envelope 210, retaining bolt 230, squib 240, and opening 250. Valve 270 is coupled to a ballonet (not shown) through tube 275. Valve 270 is under tension 220 to open and a retention mechanism, bolt 230, is used to prevent the valve 270 from opening. Tension 220 is a torsional tension (e.g., provided by a spring (not shown) coupled to the valve 270) and valve 270 rotates around axis 225 to open. FIG. 2A shows valve 270 closed, before squib 240 is actuated by the storm avoidance system, where opening 250 is misaligned with tube 275. Upon actuation, squib 240 breaks or displaces bolt 230, thereby allowing the tension 220 to open valve 270 by rotating valve 270 around axis 225 such that opening 250 is aligned with tube 275. Air 280 can then escape from the ballonet through tube 275 and opening 250. FIG. 2B shows the bolt 230 after it has been broken by the squib 240. After bolt 230 is broken, the valve 270 can move (i.e., rotate) due to the force from the tension 220. FIG. 2B shows the valve 270 after it has rotated to align opening 250 with tube 275. FIG. 2B also shows that a portion of bolt 230, coupled to valve 270, has also moved. In the example shown in FIGS. 2A and 2B, the valve rotates due to the torsional force provided by tension 220.

In different embodiments, a valve system similar to that shown in FIGS. 2A and 2B, can have a different geometry from that shown in FIGS. 2A and 2B without changing the function of the valve system. For example, the tension force can be applied in any direction (e.g., the tension force can be torsional, linear, shear, etc.), and the valve can move in any geometry (e.g., the valve can rotate, slide, etc.) to open the valve due to the tension after a retaining bolt has been broken or displaced (e.g., by a squib, or another electromechanical or electrochemical system).

In different embodiments, a valve similar to that shown in FIGS. 2A and 2B, can utilize electromechanical or electrochemical systems instead of the squib 240 shown in FIGS. 2A and 2B, without changing the basic function of the valve system. For example, the tension 220 and the retaining bolt 230 can both be omitted and the valve 270 can be moved (e.g., rotated) using an electromechanical system, such as a motor coupled to valve 270. In another example, the tension 220 and the retaining bolt 230 can both be omitted and the valve 270 can be moved (e.g., rotated) using an electrochemical system, such as a bellows or piston coupled to valve 270 that is configured to move the valve and align opening 250 with tube 275 due to the volume within the bellows or piston expanding from a product (e.g., a gas) produced by an electrochemical reaction.

In some cases, the valve 270 is opened in response to the storm avoidance system sending a signal to the squib 240, or to a different electromechanical or electrochemical system, as described herein. The signal from the storm avoidance system can be provided by a controller (or processor, or computer) of the storm avoidance system to control different components of the storm avoidance system such as mechanical actuation systems. The signal can be provided autonomously, for example, in response to the storm avoidance system detecting a state of the LTA vehicle. The signal can also be provided manually, for example, from an operator communicating with the LTA vehicle using an offboard system.

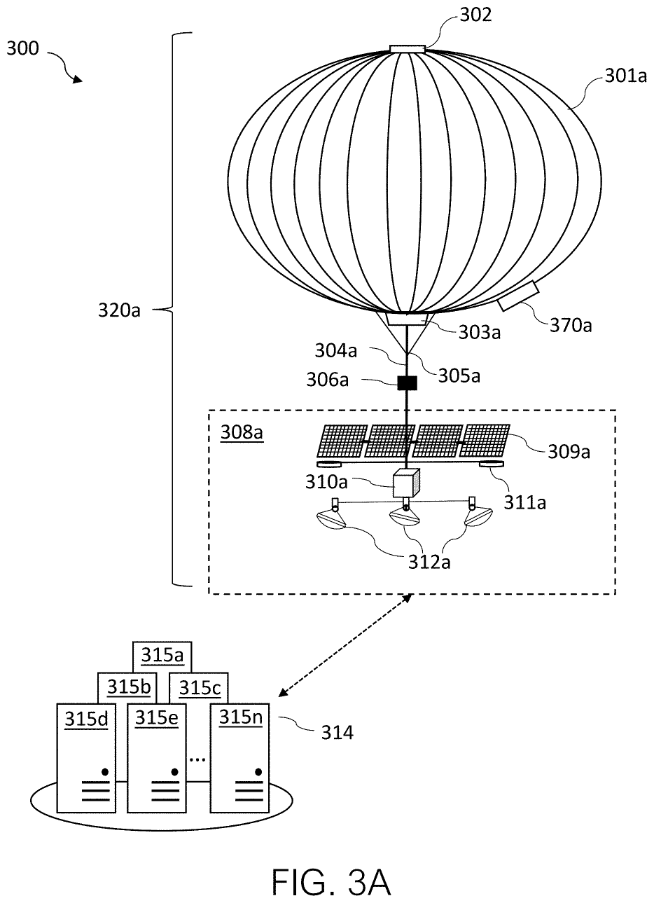

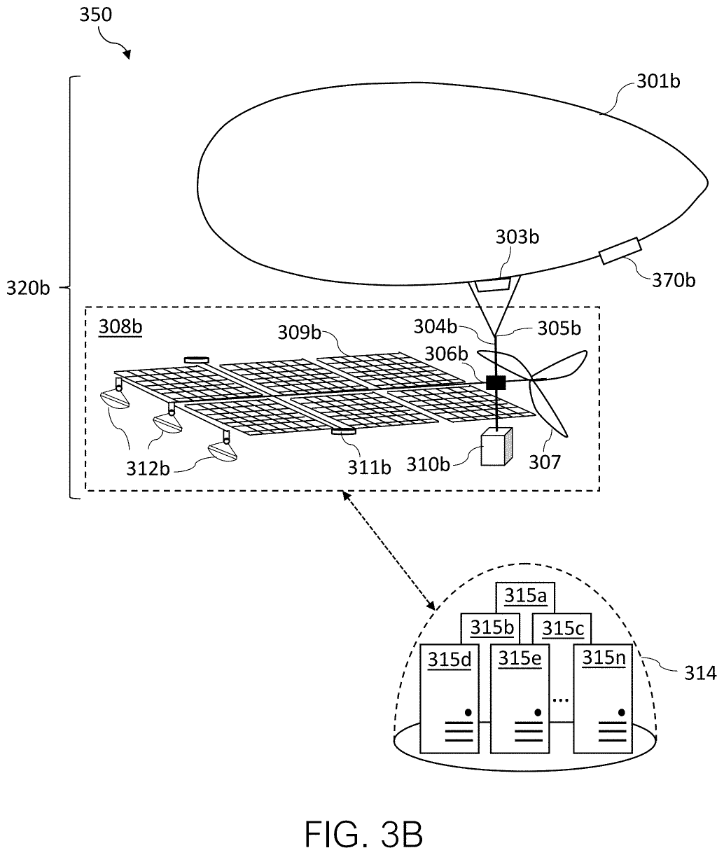

FIGS. 3A-3B are diagrams of example LTA vehicle systems incorporating storm avoidance systems, in accordance with some embodiments. The LTA vehicles 320a-b shown in FIGS. 3A-3B, and described further below, contain storm avoidance systems with valves configured to allow air to escape a ballonet (or other container) within a balloon envelope, as described above.

In FIG. 3A, there is shown a diagram of system 300 for navigation of LTA vehicle 320a. In some examples, LTA vehicle 320a may be a passive vehicle, such as a balloon, wherein most of its directional movement is a result of environmental forces, such as wind and gravity. In other examples, LTA vehicles 320a may be actively propelled. In an embodiment, system 300 may include LTA vehicle 320a and ground station 314. In this embodiment, LTA vehicle 320a may include balloon 301a, plate 302, altitude control system (ACS) 303a, valve 370a, connection 304a, joint 305a, actuation module 306a, and payload 308a. In some examples, plate 302 may provide structural and electrical connections and infrastructure. Plate 302 may be positioned at the apex of balloon 301a and may serve to couple together various parts of balloon 301a. In other examples, plate 302 also may include a flight termination unit (e.g., that is a part of the FTS system), such as one or more blades and an actuator to selectively cut a portion and/or a layer of balloon 301a. ACS 303a may include structural and electrical connections and infrastructure, including components (e.g., fans, valves, actuators, etc.) used to, for example, add and remove air from balloon 301a (i.e., in some examples, balloon 301a may include an interior ballonet within its outer, more rigid shell that is inflated and deflated), causing balloon 301a to ascend or descend, for example, to catch stratospheric winds to move in a desired direction. Valve 370 is coupled to the balloon 301a, and in some cases can be coupled to a ballonet (not shown) inside of balloon 301a. In some cases, the valve 370a can be configured to let air escape from the balloon 301a and/or a ballonet inside of balloon 301a when opened, which can cause the LTA vehicle 320a to ascend. The ACS 303a and/or valve 370a, can be used by the storm avoidance system to allow air to escape the ballonet, in some cases. For example, valve 370a can be the same or similar to valve 170 in FIG. 1, and valve 160 in FIG. 1 can be a component of an ACS (e.g., the ACS 303a). Balloon 301a may comprise a balloon envelope comprised of lightweight and/or flexible latex or rubber materials (e.g., polyethylene, polyethylene terephthalate, chloroprene), tendons (e.g., attached at one end to plate 302 and at another end to ACS 303a) to provide strength to the balloon structure, a ballonet, along with other structural components. In various embodiments, balloon 301a may be non-rigid, semi-rigid, or rigid.

Connection (i.e., down-connect) 304a may structurally, electrically, and communicatively, connect balloon 301a and/or ACS 303a to various components comprising payload 308a. In some examples, connection 304a may provide two-way communication and electrical connections, and even two-way power connections. Connection 304a may include a joint 305a, configured to allow the portion above joint 305a to pivot about one or more axes (e.g., allowing either balloon 301a or payload 308a to tilt and turn). Actuation module 306a may provide a means to actively turn payload 308a for various purposes, such as improved aerodynamics, facing or tilting solar panel(s) 309a advantageously, directing payload 308a and propulsion units (e.g., propellers 307 in FIG. 3B) for propelled flight, or directing components of payload 308a advantageously. In some cases, the down-connect 304a is configured to separate at a separation point causing the payload 308a and the balloon 301a to separate from one another (e.g., due to triggering by an FTS). In such cases, the down-connect can also include a parachute (not shown) that can be deployed to slow the descent of the payload 308a after separation.

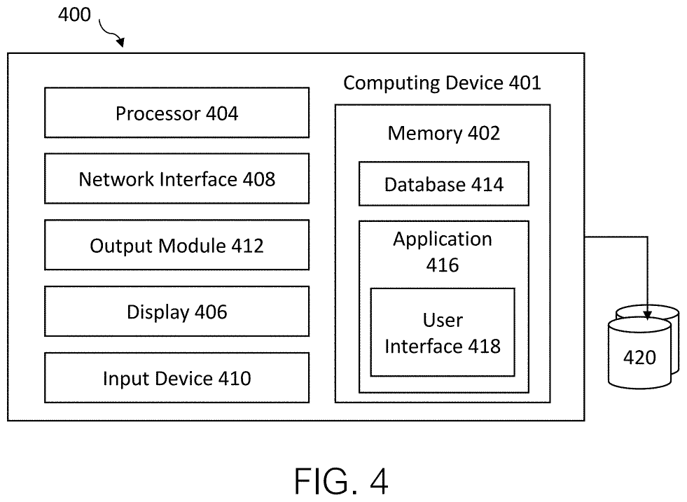

Payload 308a may include solar panel(s) 309a, avionics chassis 310a, broadband communications unit(s) 311a, and terminal(s) 312a. Solar panel(s) 309a may be configured to capture solar energy to be provided to a battery or other energy storage unit, for example, housed within avionics chassis 310a. Avionics chassis 310a also may house a flight computer (e.g., to electronically control various systems within the LTA vehicle 320a, such as computing device 401 in FIG. 4), a transponder, along with other control and communications infrastructure (e.g., a computing device and/or logic circuit configured to control LTA vehicle 320a). In some cases, the flight computer controls the storm avoidance system, for example, by actuating one or more mechanical actuation systems (e.g., squibs, electromechanical and/or electrochemical systems) in response to detecting a state of the LTA vehicle 320a. Communications unit(s) 311a may include hardware to provide wireless network access (e.g., LTE, fixed wireless broadband via 5G, Internet of Things (IoT) network, free space optical network or other broadband networks). Terminal(s) 312a may comprise one or more parabolic reflectors (e.g., dishes) coupled to an antenna and a gimbal or pivot mechanism (e.g., including an actuator comprising a motor). Terminal(s) 312(a) may be configured to receive or transmit radio waves to beam data long distances (e.g., using the millimeter wave spectrum or higher frequency radio signals). In some examples, terminal(s) 312a may have very high bandwidth capabilities. Terminal(s) 312a also may be configured to have a large range of pivot motion for precise pointing performance. Terminal(s) 312a also may be made of lightweight materials.

In other examples, payload 308a may include fewer or more components, including propellers 307 as shown in FIG. 3B, which may be configured to propel LTA vehicles 320a-b in a given direction. In still other examples, payload 308a may include still other components well known in the art to be beneficial to flight capabilities of an LTA vehicle. For example, payload 308a also may include energy capturing units apart from solar panel(s) 309a (e.g., rotors or other blades (not shown) configured to be spun by wind to generate energy). In another example, payload 308a may further include or be coupled to an imaging device (e.g., a star tracker, IR, video, Lidar, and other imaging devices, for example, to provide image-related state data of a balloon envelope, airship hull, and other parts of an LTA vehicle). In another example, payload 308a also may include various sensors (not shown), for example, housed within avionics chassis 310a or otherwise coupled to connection 304a or balloon 301a. Such sensors may include Global Positioning System (GPS) sensors, wind speed and direction sensors such as wind vanes and anemometers, temperature sensors such as thermometers and resistance temperature detectors, speed of sound sensors, acoustic sensors, pressure sensors such as barometers and differential pressure sensors, accelerometers, gyroscopes, combination sensor devices such as inertial measurement units (IMUs), light detectors, light detection and ranging (LIDAR) units, radar units, cameras, other image sensors, and more. These examples of sensors are not intended to be limiting, and those skilled in the art will appreciate that other sensors or combinations of sensors in addition to these described may be included without departing from the scope of the present disclosure.

Ground station 314 may include one or more server computing devices 315a-n, which in turn may comprise one or more computing devices (e.g., a computing device and/or logic circuit configured to control LTA vehicle 320a). In some examples, ground station 314 also may include one or more storage systems, either housed within server computing devices 315a-n, or separately. Ground station 314 may be a datacenter servicing various nodes of one or more networks.

FIG. 3B shows a diagram of system 350 for navigation of LTA vehicle 320b. All like-numbered elements in FIG. 3B are the same or similar to their corresponding elements in FIG. 3A, as described above (e.g., balloon 301a and balloon 301b may be structured and may function the same as, or similar to, each other, valve 370a and valve 370b may be the same or similar to each other in structure and function, ACS 303a and ACS 303b may be the same or similar to each other in structure and function, etc.). In some examples, balloon 301b may comprise an airship hull or dirigible balloon. In this embodiment, LTA vehicle 320b further includes, as part of payload 308b, propellers 307, which may be configured to actively propel LTA vehicle 320b in a desired direction, either with or against a wind force to speed up, slow down, or re-direct, LTA vehicle 320b. In this embodiment, balloon 301b also may be shaped differently from balloon 301a, to provide different aerodynamic properties.

As shown in FIGS. 3A-3B, LTA vehicles 320a-b may be largely wind-influenced LTA vehicle, for example, balloons carrying a payload (with or without propulsion capabilities) as shown. However, those skilled in the art will recognize that the systems disclosed herein may similarly apply and be usable by various other types of LTA vehicles.

FIG. 4 is a simplified block diagram of an example of a computing system forming part of the systems of FIGS. 3A-3B, in accordance with one or more embodiments. Any reference to a computer (e.g., flight computer, server, etc.) herein may be implemented using the computing system 400 in FIG. 4. In some cases, the computing system 400 is coupled to different components of the storm avoidance system. In some cases, computing system 400 can contain the processor (or computer, or controller) that controls the mechanical actuation system of the storm avoidance system (e.g., a squib system, an electromechanical system, and/or an electrochemical system). For example, computing system 400 can be coupled to sensors and/or other systems of the LTA vehicle to determine a state of the LTA vehicle, and control mechanical actuation systems such as squibs to open a valve in response to detecting the state of the LTA vehicle. Some examples of states of the LTA vehicle that can cause the storm avoidance system to engage are a partial or total loss of command and control, a proximity to a storm, a proximity to an aircraft flight route, and/or a proximity to a high population density region.

In one embodiment, computing system 400 may include computing device 401 and storage system 420. Storage system 420 may comprise a plurality of repositories and/or other forms of data storage, and it also may be in communication with computing device 401. In another embodiment, storage system 420, which may comprise a plurality of repositories, may be housed in one or more of computing device 401 (not shown). In some examples, storage system 420 may store state data, commands, flight policies, and other various types of information (e.g., pressure measurements, thresholds and offsets) as described herein. This information may be retrieved or otherwise accessed by one or more computing devices, such as computing device 401 or server computing devices 410 in FIG. 4, in order to perform some or all of the features described herein. Storage system 420 may comprise any type of computer storage, such as a hard-drive, memory card, ROM, RAM, DVD, CD-ROM, write-capable, and read-only memories. In addition, storage system 420 may include a distributed storage system where data is stored on a plurality of different storage devices, which may be physically located at the same or different geographic locations (e.g., in a ground station (e.g., 314 in FIGS. 3A-3B), or in a distributed computing system (not shown)). Storage system 420 may be networked to computing device 401 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 401 also may include a memory 402. Memory 402 may comprise a storage system configured to store a database 414 and an application 416. Application 416 may include instructions which, when executed by a processor 404, cause computing device 401 to perform various steps and/or functions, as described herein. Application 416 further includes instructions for generating a user interface 418 (e.g., graphical user interface (GUI)). Database 414 may store various algorithms and/or data, including neural networks (e.g., encoding flight policies, as described herein) and data regarding wind patterns, weather forecasts, past and present locations of aerial vehicles (e.g., aerial vehicles 120a-b, 201a-b, 211a-c), sensor data, map information, air traffic information, among other types of data. For example, database 414 may store state information of the LTA vehicle, as described herein. Memory 402 may include any non-transitory computer-readable storage medium for storing data and/or software that is executable by processor 404, and/or any other medium which may be used to store information that may be accessed by processor 404 to control the operation of computing device 401.

Computing device 401 may further include a display 406, a network interface 408, an input device 410, and/or an output module 412. Display 406 may be any display device by means of which computing device 401 may output and/or display data. Network interface 408 may be configured to connect to a network using any of the wired and wireless short range communication protocols described above, as well as a cellular data network, a satellite network, free space optical network and/or the Internet. Input device 410 may be a mouse, keyboard, touch screen, voice interface, and/or any or other hand-held controller or device or interface by means of which a user may interact with computing device 401. Output module 412 may be a bus, port, and/or other interface by means of which computing device 401 may connect to and/or output data to other devices and/or peripherals.

In some examples, computing device 401 may be located offboard the LTA vehicle (e.g., offboard aerial vehicles 320a-b, such as in ground station 314, in FIGS. 3A-3B) and may communicate with and/or control the operations of an aerial vehicle, or its control infrastructure as may be housed in avionics chassis 310a-b, via a network. In one embodiment, computing device 401 is a data center or other control facility (e.g., configured to run a distributed computing system as described herein), and may communicate with a controller and/or flight computer housed in avionics chassis 310a-b via a network. As described herein, system 400, and particularly computing device 401, may be used for planning a flight path or course for an aerial vehicle based on wind and weather forecasts to move said aerial vehicle along a desired heading or within a desired radius of a target location. Various configurations of system 400 are envisioned, and various steps and/or functions of the processes described below may be shared among the various devices of system 400, or may be assigned to specific devices.

Example Methods

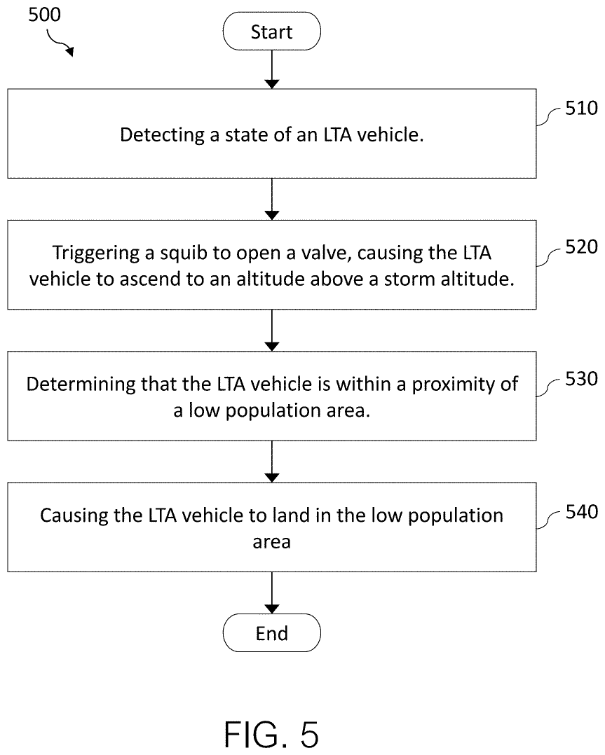

FIG. 5 is a flowchart of a method 500 for operating a storm avoidance system of an LTA vehicle. In step 510, a state of an LTA vehicle is detected, for example using a processor. For example, a state of an LTA vehicle that can cause the storm avoidance system to engage may include a partial or total loss of command and control, or a flight duration time longer than a predetermined flight duration time (e.g., an estimated healthy lifetime of the LTA vehicle). Other examples of states of the LTA vehicle that can be detected are a proximity to a storm, a proximity to an aircraft flight route, and/or a proximity to a high population density region. In step 520, a squib is triggered to open a valve. The squib can be triggered using a squib controller to open a valve coupled to one or both of a balloon envelope and a ballonet in response to the state of the LTA vehicle. Opening the valve causes air to be released from the balloon envelope and/or the ballonet, thereby causing the LTA vehicle to ascend to an altitude above a storm altitude. In step 530, it is determined that the LTA vehicle is within a proximity of a low population area. In some cases, the LTA vehicle drifts until it is over a low population area. In some cases, an FTS may instruct the LTA vehicle to drift in a low power mode while waiting to find a low population area to safely descend. In step 540, the LTA vehicle is caused to land in the low population area. In some cases, an FTS may cause the LTA vehicle to descend using a flight termination unit having one or more blades and an actuator to selectively cut a portion and/or a layer of balloon containing lifting gas.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements.

What is claimed is:

1. A storm avoidance system for a lighter than air (LTA) vehicle, comprising:
a mechanical actuation system being controlled by a mechanical actuation system controller;
a balloon envelope comprising a ballonet; and
a valve coupled to one or both of the balloon envelope and the ballonet, the valve configured to allow air to escape the ballonet,
wherein the mechanical actuation system controller is configured to cause the mechanical actuation system to open the valve, and
wherein the air escaping the ballonet causes the LTA vehicle to ascend to an altitude above a storm altitude.

2. The storm avoidance system of claim 1, wherein the mechanical actuation system comprises a squib configured to cause the valve to open.

3. The storm avoidance system of claim 2, wherein the valve further comprises a spring configured to provide a tension, and a retaining bolt configured to prevent the valve from opening until the retaining bolt is broken or displaced by the squib.

4. The storm avoidance system of claim 1, wherein the mechanical actuation system comprises an electromechanical system configured to cause the valve to open.

5. The storm avoidance system of claim 1, wherein the mechanical actuation system controller is configured to autonomously actuate the mechanical actuation system to trigger in response to a state of the LTA vehicle.

6. The storm avoidance system of claim 5, wherein the state of the LTA vehicle comprises at least a partial loss of command and control of the LTA vehicle.

7. The storm avoidance system of claim 1, wherein the mechanical actuation system controller is configured to cause the mechanical actuation system to trigger in response to a manual signal from an operator.

8. The storm avoidance system of claim 1, wherein the valve is controlled independently from an altitude control system.

9. The storm avoidance system of claim 1, wherein the storm altitude is 40,000 feet or above.

10. A method for operating a storm avoidance system for an LTA vehicle, comprising:
detecting, using a processor, a state of an LTA vehicle;
triggering a mechanical actuation system, using a mechanical actuation system controller, the mechanical actuation system configured to open a valve coupled to one or both of a balloon envelope and a ballonet, wherein the ballonet is filled with air, and wherein opening the valve causes the air to escape the ballonet and causes the LTA vehicle to ascend to an altitude above a storm altitude;
determining that the LTA vehicle is within a proximity of a low population area, the proximity indicating an appropriate distance and direction of travel to begin a descent for landing in the low population area; and
causing the LTA vehicle to land in the low population area.

11. The method of claim 10, wherein the triggering the mechanical actuation system comprises firing a squib, wherein the squib is configured to open the valve.

12. The method of claim 10, wherein the triggering the mechanical actuation system comprises actuating an electromechanical system configured to open the valve.

13. The method of claim 10, wherein the triggering the mechanical actuation system comprises autonomously actuating the mechanical actuation system to trigger in response to a state of the LTA vehicle.

14. The method of claim 13, wherein the state of the LTA vehicle comprises a partial loss of command and control or a total loss of command and control, or a flight duration time longer than a predetermined flight duration time.

15. The method of claim 10, wherein the triggering of the mechanical actuation system controller is performed in response to a manual signal from an operator.

16. The method of claim 10, wherein the storm altitude is 40,000 feet or above.

17. The method of claim 10, further comprising receiving data from a forecast or a nowcast model, wherein the data includes one or more of a location of a storm, a proximity of a storm to the LTA vehicle, the maximum altitude of a storm, a projected direction or travel and/or a projected speed of travel of a storm.

18. The method of claim 17, wherein the data is used by the weather avoidance system to determine when to trigger the mechanical actuation system.

19. The method of claim 10, further comprising, after triggering the mechanical actuation system and before causing the LTA vehicle to land in the low population area, causing the LTA vehicle to drift in a low power mode.

20. The method of claim 10, wherein the descending the LTA vehicle until it touches down in the low population area further comprises selectively cutting, using a flight termination unit, a portion and/or a layer of the balloon envelope containing lifting gas.
